(19) United States
(12) Patent Application Publication
(10) Pub. No.: US 2017/0251090 A1
(43) Pub. Date: Aug. 31, 2017

(54) METHOD AND DEVICE FOR PRESENTING INFORMATION

(71) Applicant: Beijing Xiaomi Mobile Software Co., Ltd., Beijing (CN)

(72) Inventors: Qian Wang, Beijing (CN); Yin Zhu, Beijing (CN); Lan Li, Beijing (CN)

(73) Assignee: Beijing Xiaomi Mobile Software Co., Ltd., Beijing (CN)

(21) Appl. No.: 15/296,307

(22) Filed: Oct. 18, 2016

(30) Foreign Application Priority Data
Feb. 26, 2016 (CN) 201610109885.8

(51) Int. Cl. H04M 1/2745; H04M 1/725

(52) U.S. Cl. CPC H04M 1/274583; H04M 1/72583; H04M 2250/60; H04M 2201/42

(57) ABSTRACT

The present disclosure relates to a method and a device for presenting information, belonging to the field of computer technology. The method includes: obtaining service information related to a service if a service-type call log exists in call logs of a computing device; and inserting the service information into the service-type call log and displaying the service information.

### CROSS-REFERENCE TO RELATED APPLICATION

This application claims priority to Chinese Patent Application Serial No. 201610109885.8, filed with the State Intellectual Property Office of P. R. China on Feb. 26, 2016, the entirety of which is hereby incorporated by reference herein.

### FIELD

The present disclosure relates to a computer technology, and more particularly relates to a method and a device for presenting information gathered with relation to call logs within the field of computer technology.

### BACKGROUND

Telephone call logs record basic information of a call, such as contact information, phone number, incoming call time, calling out time, number of calls, and phone number for attribution, among other call related information. A user may access such basic information without further access to information related to service calls.

### SUMMARY

Embodiments of the present disclosure provide a method and a device for presenting information. The technical solutions will be described as follows.

According to a first embodiment of the present disclosure, a method for presenting information is provided. The method is applied in a computing device, and includes: obtaining service information related to a service if a service-type call log exists in call logs of the computing device; and inserting the service information into the service-type call log and displaying the service information.

According to a second embodiment of the present disclosure, a device for presenting information is provided. The device may be a computing device that includes: an information obtaining module, configured to obtain service information related to a service if a service-type call log exists in call logs of the computing device; and an information displaying module, configured to insert the service information into the service-type call log and display the service information.

According to a third embodiment of the present disclosure, a device for presenting information is provided. The device includes: a processor; a memory for storing executable instruction of the processor; the processor is configured to execute the executable instructions to: obtain service information related to a service if a service-type call log exists in call logs of a computing device; and insert the service information into the service-type call log and display the service information.

It should be understood that the above general descriptions and the following detail descriptions are explanatory and illustrative, and these descriptions shall not be construed to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart of a method for presenting information according to an embodiment of the present disclosure;

FIG. 2 is a flow chart of a method for presenting information according to an embodiment of the present disclosure;

FIG. 3 is an exemplary schematic diagram illustrating an information presenting process according to an embodiment of the present disclosure;

FIG. 4 is an exemplary schematic diagram illustrating an information presenting process according to an embodiment of the present disclosure;

FIG. 5 is an exemplary schematic diagram illustrating an information presenting process according to an embodiment of the present disclosure;

FIG. 6 is a block diagram of a device for presenting information according to an embodiment of the present disclosure;

FIG. 7 is a block diagram of a device for presenting information according to an embodiment of the present disclosure;

FIG. 8 is a block diagram of a device for presenting information according to an embodiment of the present disclosure; and

FIG. 9 is a block diagram of a device for presenting information according to an embodiment of the present disclosure.

Embodiments of the present disclosure are illustrated in the above accompany drawings and will be described in further detail hereinafter. These accompany drawings and literal description are not intended to limit the scope of the idea of the present disclosure, but to explain the principle of the present disclosure with reference to particular embodiments for those skilled in the art.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of devices and methods consistent with aspects related to the disclosure as recited in the appended claims.

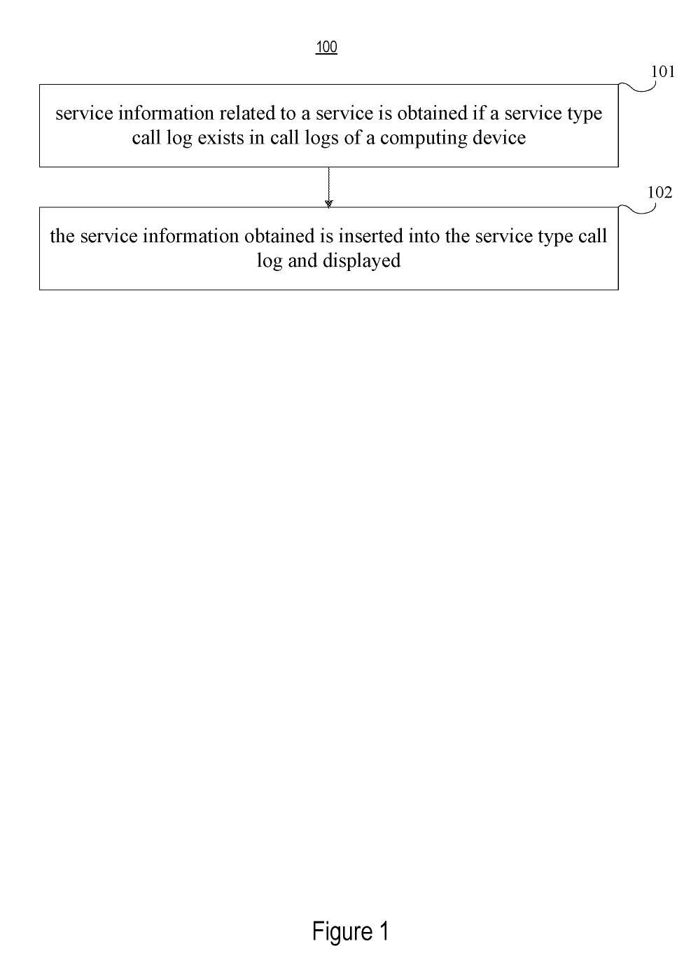

FIG. 1 is a flow chart 100 describing a method for presenting information according to an embodiment of the present disclosure. The method for presenting information may be applied in a mobile computing device with a communication function, such as a mobile phone or laptop computer. As shown in FIG. 1, the method may include following processes.

At block 101, service information related to a service is obtained when a service-type call log exists in call logs of the computing device. For example, the computing device may store a list of call logs describing incoming, and/or outgoing, calls received and dialed-out from the computing device. Of the calls described in the list of call logs, those call logs that are determined to relate to a service provider or a service application running on the computing device, may be identified as service-type call logs. Therefore, a service-type call may be distinguishable from other types of calls as the service-type call relates to calls from, or to, a service provider such as, for example, an express delivery service provider, a take-out restaurant service provider, a taxi-calling service provider, or a ticket-booking service provider.

The service information may be obtained separately, and identify certain functions that are applicable to the service provider (e.g., calling the service provider, setting up payments to the service provider, requesting a service from the service provider, cancelling a service from the service provider, or the like). The service information related to the service may be obtained in response to a request for such information received from a user input or a request from an application (e.g., service recommendation application) running on the computing device.

At block 102, the obtained service information is inserted into the service-type call log entry that is displayed on the GUI. For example, the obtained service information may be auto-populated into data fields related to the service call type call log entry included in the GUI. The GUI may be part of an application running on the computing device that identifies a call log of incoming and/or outgoing calls to and/or from the computing device, and also includes service information related to the call log entries where applicable.

According to some embodiments, a new tag is added into the service-type call log, and then the obtained service information is inserted into the tag and displayed.

The tag is an interactive data function field that provides (e.g., displays) information describing a function that will be activated in response to an interaction with the tag. The tag may then receive a user interaction (e.g., user input selecting the tag), and in response to the received user interaction, control execution of the function described by the tag.

As the technical solution, the service information related to the service may be obtained if the service-type call log exists in call logs of the computing device and the obtained service information is inserted into the service-type call log and displayed, such that a user may have access to related service information extracted from the call logs without calling other service function applications to inquire about the related service information.

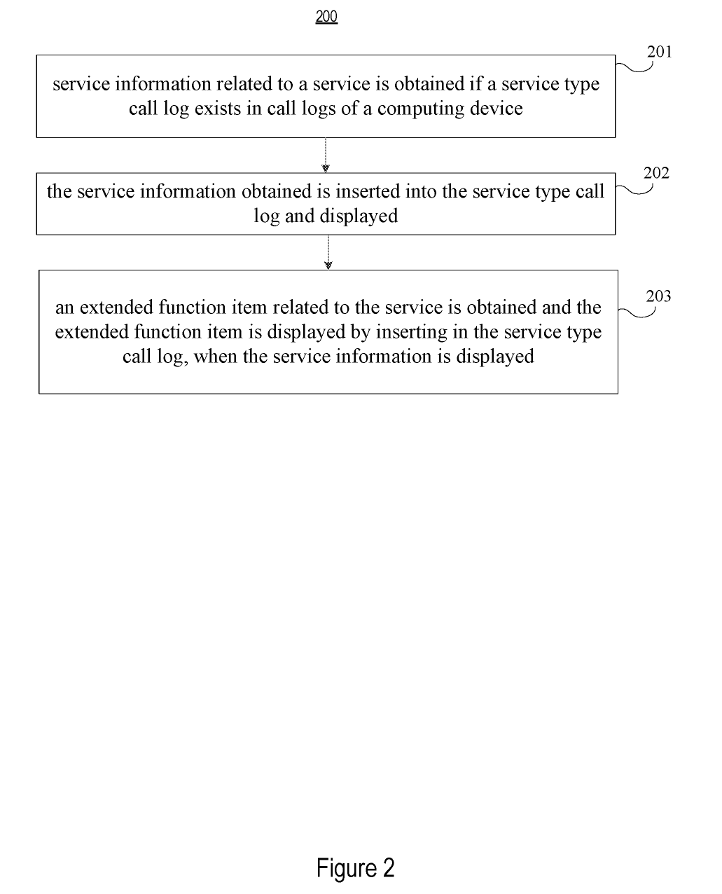

FIG. 2 is a flow chart 200 describing a method for presenting information according to an embodiment of the present disclosure. The method for presenting information may be applied in a mobile computing device with a communication function, such as a mobile phone or laptop computer. As shown in FIG. 2, the method may include following acts.

At block 201, service information related to a service is obtained when a service-type call log is determined to be included in a list of call logs stored on the computing device.

According to this technical solution of the present disclosure, in order to detect whether the service-type call log exists in the call logs of the computing device, the call logs stored on the computing device may be matched against a database of service provider descriptions stored in a cloud service (herein, contact information of various services is stored in the cloud service), so as to determine whether one or more of the call logs stored on the computing device match to a service provider description stored on the cloud service. This way, the cloud service may determine whether a call log stored on the computing device belong to a service provider, and service provider information included in the matching service provider description may be communicated back to the computing device. When a call log stored on the computing device is determined to have a matching service provider description, the call log may be considered a service-type call log.

At block 202, the obtained service information may be inserted into the service-type call log entry that is displayed on the GUI. For example, the obtained service information may be auto-populated into data fields related to the service call type call log entry included in the GUI.

According to this technical solution of the present disclosure, the obtained service information may be displayed by inserting the obtained service information relating to the service-type call log in a preset layout manner within the GUI displayed on the computing device.

According to this technical solution of the present disclosure, a service-type call log may be arranged on the top of the call log GUI by default when the service corresponding to the service-type call log is presently running on the computing device. Here, when there are several service related applications running on the computing device, the respective service-type call log may be displayed on the GUI in a chronological order according to when a user last contacted the corresponding service provider (most recent to oldest, or oldest to most recent).

At block 203, an extended function item related to the service related to the determined service-type call log is obtained and the extended function item is inserted into the service-type call log entry displayed on the graphical user interface, at the same time when the obtained service information is inserted into the data fields of the graphical user interface related to the service-type call log.

In an embodiment, a new tag is added into the related service-type call log, and then the obtained extended function item is inserted into the tag and displayed on the GUI.

According to this technical solution of the present disclosure, the extended function item related to the service refers to a function item provided by the service that can be operated by users. For example, when the service application is a taxi-calling service application, the extended function item related to this service may be: a payment function, an evaluation function or a service cancelling function. The service application and the extended functions related thereto may be bound and stored in advance as preset settings on a memory included in the computing device. Thus, when it is necessary to provide the extended functions corresponding to a service-type provider or service application to a user, the extended functions related to the service provider or service application may be obtained and provided to the user directly by referencing the preset settings. In this way, when the user selects to operate the extended function item described in the service-type call log, the extended function item may be executed. The user may also accomplish several functions in the call log interface.

With these technical solutions, the service information related to the service is obtained when the service-type call log is determined to exist in call logs stored on a computing device. Service information related to the service-type call log may also be obtained and inserted into the service-type call log and displayed on a GUI, such that a user is allowed to obtain related service information from the call logs without calling other service function to inquire about the related service information.

The implementations of above technical solutions are described in more detail hereinafter by combining with specific application scenarios.

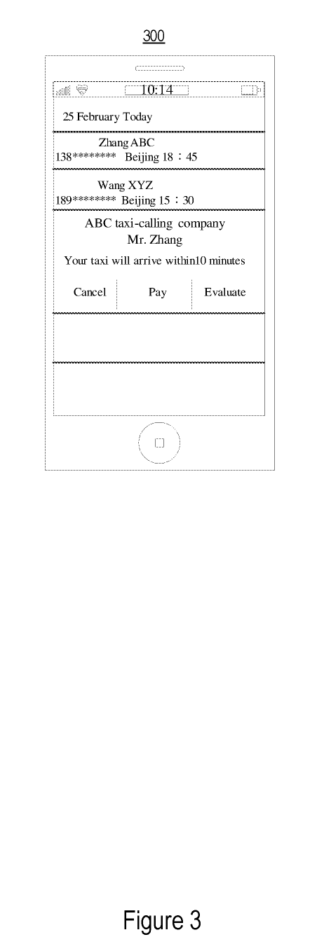

FIGS. 3-5 display exemplary call log GUIs. As shown in FIG. 3, a call log GUI 300 indicates a user A calls a taxi and knows that the called phone number belongs to Mr. Zhang of ABC taxi-calling company by requesting the cloud service to match the known phone number of Mr. Zhang to a service provider profile. Then, the progress information (such as the arrival time) related to the service may be obtained from a service provider server for the ABC taxi-calling company that is running the taxi service. The progress information may be looked up by the service provider server by sending a request that includes Mr. Zhang's phone number obtained from the call log. The obtained progress information may be displayed along with the call log on the call log GUI 300. In a specific implementation, an extended function related to the service, such as service cancelling function, payment and evaluation function, may be obtained and displayed in the call log GUI 550, so as to allow the user to accomplish the payment function or the service cancelling and evaluation function directly in the call log GUI 300.

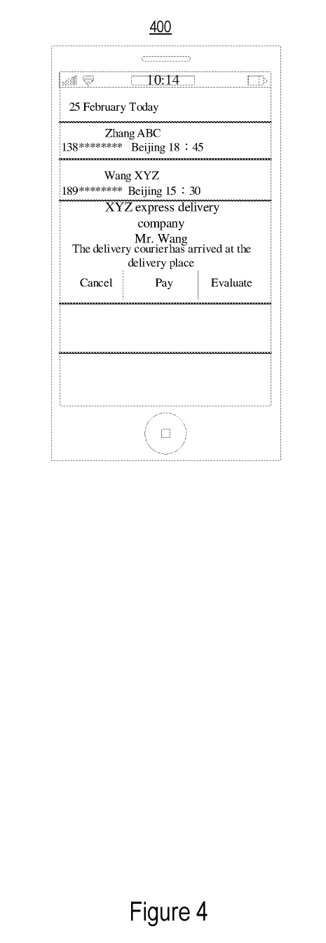

As shown in FIG. 4, a call log GUI 400 indicates user A calls Mr. Wang of XYZ express delivery company and requests sending a good somewhere. Then, the progress information (such as if arriving at the delivery place or not) related to the service offered by XYZ express delivery company may be obtained from the background server of XYZ express delivery company according to Mr. Wang's phone number obtained from the call log, and the progress information is displayed in the call log GUI 400. In a specific implementation, an extended function related to the service, such as service cancelling function, payment and evaluation function, may be obtained and displayed in the call log GUI 400, so as to allow the user to accomplish the payment function or the service cancelling and evaluation function in the call log interface.

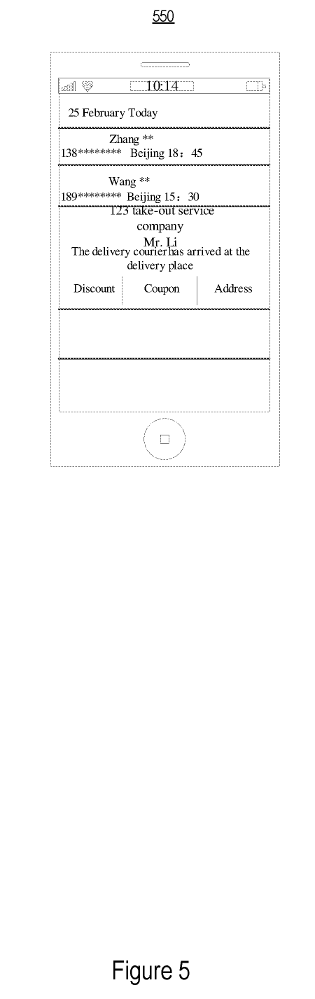

As shown in FIG. 5, a call log GUI 550 indicates user A calls for a take-out service and knows that the called phone number belongs to Mr. Li of 123 take-out service company by requesting the cloud service to match the known phone number of Mr. Li to a service provider profile. Then, the progress information (such as if arriving at the delivery place or not) related to the service may be obtained from a service provider server for the 123 take-out service company that is running the take-out service. The progress information may be looked up by the service provider server by sending a request that includes Mr. Li's phone number obtained from the call log. The obtained progress information may be displayed along with the call log on the call log GUI 550. In a specific implementation, an extended function related to the service, such as coupons, address of the restaurant and discount information, may be obtained and displayed in the call log GUI 550, so as to allow the user to obtain coupons, address and discount information in the call log GUI 550.

The device embodiments of the present disclosure which may be configured to perform the method embodiments of the present disclosure will be explained below. For the details not disclosed in the device embodiments of the present disclosure, please refer to the method embodiments of the present disclosure.

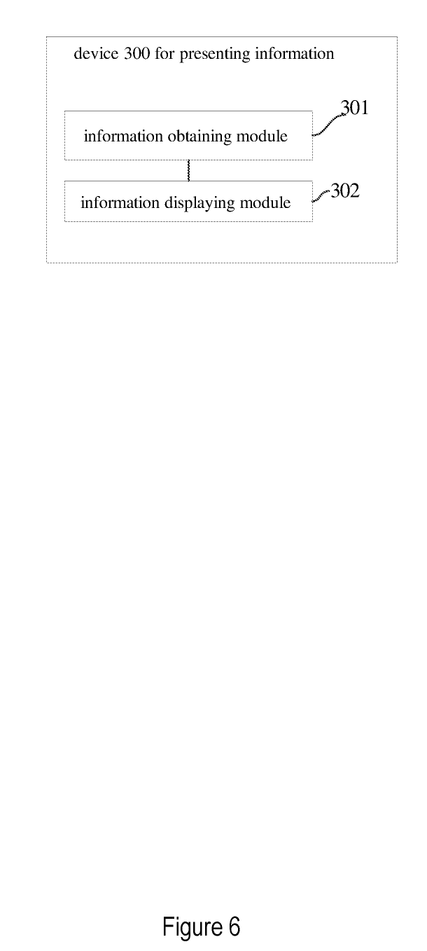

FIG. 6 is a block diagram of a device 300 for presenting information according to an embodiment of the present disclosure. The device 300 for presenting information may be implemented as a part or a whole of a computing device by software, hardware of a combination thereof. The computing device may be an electronic displaying device such as a mobile phone. The device 300 for presenting information may include: an information obtaining module 301, configured to obtain service information related to a service if a service-type call log exists in call logs of a computing device; and an information displaying module 302, configured to insert the service information into the service-type call log and display the service information.

With the technical solution, the service information related to the service may be obtained if the service-type call log exists in call logs of a computing device and the obtained service information is inserted into the service-type call log and displayed, such that a user is allowed to obtain related service information from the call logs without calling other service function to inquire related service information.

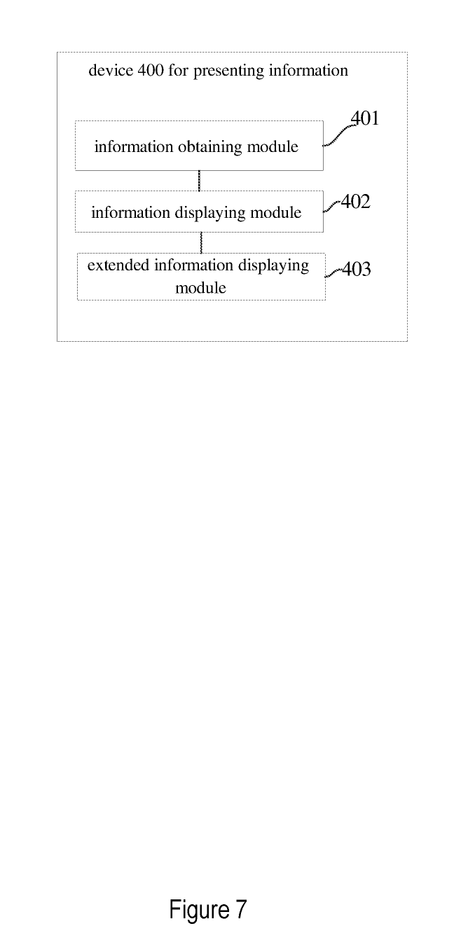

FIG. 7 is a block diagram of a device 400 for presenting information according to an embodiment of the present disclosure. The device 400 for presenting information may be implemented as a part or a whole of a computing device by software, hardware of a combination thereof. The computing device may be an electronic displaying device such as a mobile phone. The device 400 for presenting information may include: an information obtaining module 401, configured to obtain service information related to a service if a service-type call log exists in call logs of a computing device; an information displaying module 402, configured to insert the service information into the service-type call log and display the service information; and an extended information displaying module 403, configured to obtain an extended function item related to the service, to insert the extended function item into the service-type call log and to display the extended function item, when the service information obtained is inserted into the service-type call log and displayed.

The information obtaining module 401 may be configured to obtain the service information related to the service from a background server, in which the service information at least includes progress information of the service.

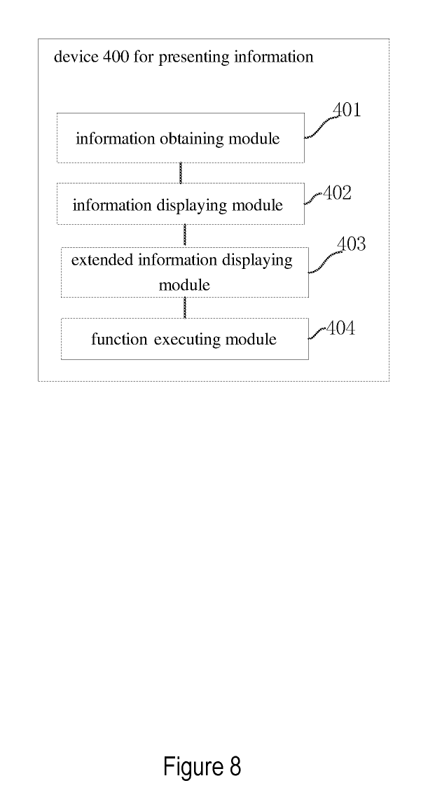

As shown in FIG. 8, the device 400 for presenting information may also include: a function executing module 404, configured to go to execute the extended function item if a user selects to operate the extended function item in the service-type call log.

The service-type at least includes: an express delivery service, a take-out service, a taxi-calling service or a ticket-booking service.

The information displaying module 402 may be further configured to arrange a call log corresponding to the service on top of a call log interface by default if the service is in progress.

In conclusion, with the technical solution, the service information related to the service may be obtained if the service-type call log exists in call logs of a computing device and the obtained service information may be inserted into the service-type call log and displayed, such that a user is allowed to obtain related service information from the call logs without calling other service function to inquire related service information.

With respect to the device in the above embodiments, specific manners for respective modules performing operations have been described in detail in related method embodiments and detailed descriptions thereof are omitted herein.

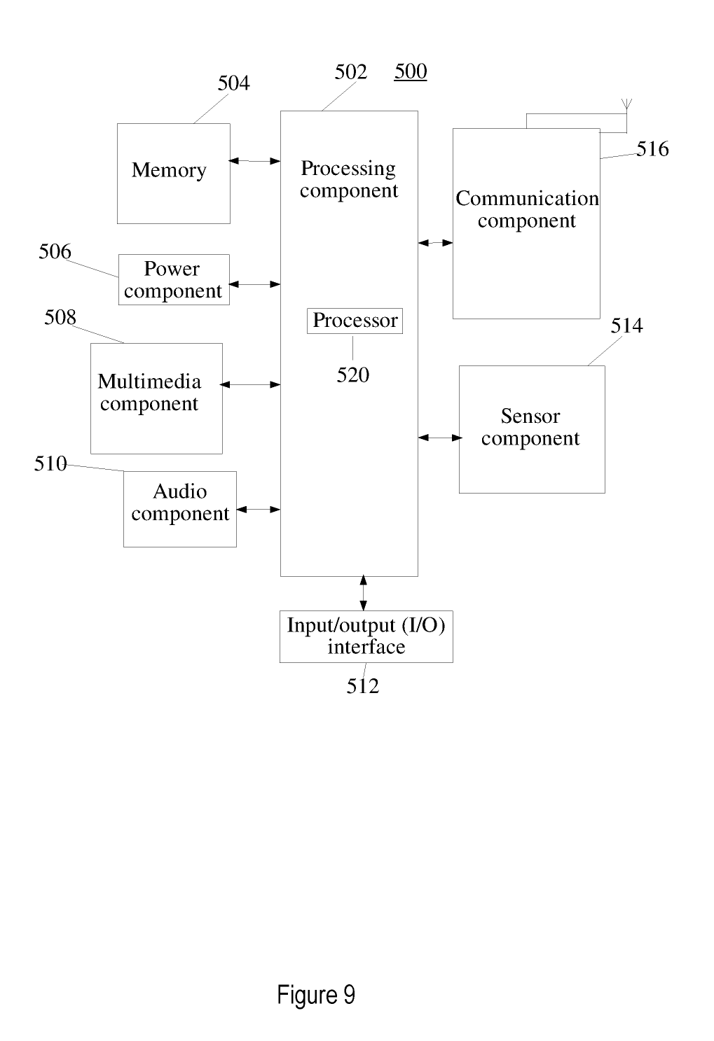

FIG. 9 is a block diagram of a device 500 for presenting information according to an embodiment of the present disclosure. For example, the device 500 may be a computing device such as a mobile phone, a tablet computer or a smart television etc.

Referring to FIG. 9, the device 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the device 500, such as the operations associated with display, telephone calls, data communications, camera operations, and recording operations. The processing component 502 may include one or more processors 520 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the device 500. Examples of such data include instructions for any applications or methods operated on the device 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the device 500. The power component 506 may include a power management system, one or more power sources, and any other components associated with the generation, management, and distribution of power in the device 500.

The multimedia component 508 includes a screen providing an output interface between the device 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. The front camera and the rear camera may receive an external multimedia datum while the device 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone (“MIC”) configured to receive an external audio signal when the device 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the device 500. For instance, the sensor component 514 may detect an open/closed status of the device 500, relative positioning of components, e.g., the display and the keypad, of the device 500, a change in position of the device 500 or a component of the device 500, a presence or absence of user contact with the device 500, an orientation or an acceleration/deceleration of the device 500, and a change in temperature of the device 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the device 500 and other devices. The device 500 can access a wireless network based on a communication standard, such as WiFi, 2G or 3G or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 504, executable by the processor 520 in the device 500, for performing the above-described methods. For example, the non-transitory computer-readable storage medium may be a ROM, a RAM, a CD-ROM, a magnetic tape, a floppy disc, an optical data storage device, and the like.

A non-transitory computer-readable storage medium has stored therein instructions that, when executed by a processor, causes the device 500 to perform the method for presenting information.

Each module, submodule, or unit discussed above for FIGS. 6-8, may take the form of a packaged functional hardware unit designed for use with other components, a portion of a program code (e.g., software or firmware) executable by the processor 520 or the processing circuitry that usually performs a particular function of related functions, or a self-contained hardware or software component that interfaces with a larger system, for example.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for presenting information executed by a computing device, the method comprising:
determining whether a service-type call log exists within a list of call logs stored on a memory of the computing device, the service-type call log corresponding to a service provider identified as providing a service;
obtaining service information related to the service when a service-type call log is determined to exist in call logs of the computing device; and
displaying a graphical user interface including the service-type call log and the service information.

2. The method according to claim 1, wherein obtaining the service information related to the service comprises:
obtaining the service information related to the service from a background server, wherein the service information comprises at least progress status information related to the service.

3. The method according to claim 2, further comprising:
obtaining an extended function item related to the service; and
displaying the graphical user interface to further include the extended function item.

4. The method according to claim 3, further comprising:
receiving a user command selecting the extended function item; and
executing an extended function corresponding to the extended function item in response to receiving the user command.

5. The method according to claim 4, wherein the service-type comprises: at least one of an express delivery service, a take-out service, a taxi-calling service, or a ticket-booking service.

6. The method according to claim 1, further comprising:
obtaining an extended function item related to the service; and
displaying the graphical user interface to further include the extended function item.

7. The method according to claim 6, further comprising:
receiving a user command selecting the extended function item; and
executing an extended function corresponding to the extended function item in response to receiving the user command.

8. The method according to claim 1, wherein the service-type comprises: at least one of an express delivery service, a take-out service, a taxi-calling service and a ticket-booking service.

9. The method according to claim 1, further comprising:
determining whether the service is being executed; and
when the service is determined to being executed, controlling display of the service-type call log to display the service being executed at a top of the call log in the graphical user interface.

10. The method of claim 1, further comprising:
obtaining an extended function item related to the service from preset settings stored in the memory of the computing device; and
displaying the graphical user interface to further include the extended function item.

11. The method of claim 1, further comprising:
transmitting a request to a background server corresponding to the service provider, the request including the list of call logs; and
receiving, from the background server, confirmation of the service-type call log included in the list of call logs.

12. The method of claim 1, further comprising:
obtaining an extended function item related to the service from preset settings stored in the memory of the computing device, the extended function item corresponding to at least one of a coupon, an address, or a discount corresponding to the service;
displaying the graphical user interface to further include the extended function item;
receiving a user command selecting the extended function item; and
executing an extended function corresponding to the extended function item in response to receiving the user command.

13. A computing device for presenting information, comprising:
a processor;
a memory for storing processor executable instructions;
wherein the processor is configured to execute the processor executable instructions to:
determine whether a service-type call log exists within a list of call logs stored on the memory of the computing device, the service-type call log corresponding to a service provider identified as providing a service;
obtain service information related to the service when a service-type call log is determined to exist in call logs of the computing device; and
display a graphical user interface including the service-type call log and the service information.

14. The computing device according to claim 13, wherein the processor is configured to obtain the service information related to the service from a background server, wherein the service information comprises at least progress status information related to the service.

15. The computing device according to claim 14, wherein the processor is further configured to:
obtain an extended function item related to the service; and
display the graphical user interface to further include the extended function item.

16. The computing device according to claim 13, wherein the processor is further configured to:
receive a user command selecting the extended function item; and
execute an extended function corresponding to the extended function item in response to receiving the user command.

17. The computing device according to claim 16, wherein the service-type comprises: at least one of an express delivery service, a take-out service, a taxi-calling service, or a ticket-booking service.

18. The computing device according to claim 13, wherein the processor is further configured to:
obtain an extended function item related to the service; and
display the graphical user interface to further include the extended function item.

19. The computing device according to claim 18, wherein the processor is further configured to:
receive a user command selecting the extended function item; and
execute an extended function corresponding to the extended function item in response to receiving the user command.

20. A non-transitory memory configured to store processor executable instructions for causing a processor to:
determine whether a service-type call log exists within a list of call logs stored on the memory of the computing device, the service-type call log corresponding to a service provider identified as providing a service;
obtain service information related to the service when a service-type call log is determined to exist in call logs of the computing device; and
display a graphical user interface including the service-type call log and the service information.
